(19) United States
(12) Patent Application Publication
(10) Pub. No.: US 2024/0050878 A1
(43) Pub. Date: Feb. 15, 2024

(54) FILTER DEVICE AND FILTER ELEMENT

(71) Applicant: Hydac Filtertechnik GmbH, Sulzbach/Saar (DE)

(72) Inventors: Dirk RÖDER, Saarbrücken (DE); Stefan HENNES, Neunkirchen (DE)

(21) Appl. No.: 17/887,625

(22) Filed: Aug. 15, 2022

(51) Int. Cl. B01D 35/30; B01D 35/147

(52) U.S. Cl. CPC B01D 35/30; B01D 35/147; B01D 2201/304; B01D 2201/291

(57) ABSTRACT

A filter device and a filter element (14) having a filter head (10) and having a filter bowl (12) for mounting the replaceable filter element (14), characterized in that a compensation device (16) is provided, which acts between the filter head (10) and the filter element (14) and which, as a component of the filter element (14), has two shell parts (18, 20), one shell part (18) of which is secured stationarily to the filter element (14) and the other shell part (20) of which, in contrast, is designed to be movably guided, and in that one of the two shell parts (20) has a passage opening (22) for guiding a fluid flow.

The invention relates to a filter device having a filter head and having a filter bowl for mounting a replaceable filter element, and to the filter element itself.

DE 101 42 774 A1 discloses a filter device of the type comprising a pot-like filter housing defining a longitudinal axis along which a filter element can be inserted into and removed from the filter housing, and comprising a retaining device for detachably securing the filter element in the filter housing, which retaining device comprises first and second retaining elements provided on the inside of the filter housing and on the filter element, wherein at least one of the retaining elements has a shape concentric with the longitudinal axis of the filter housing and forming at least a portion of a thread, so that the filter element is secured by a form-fitting connection after rotation about its longitudinal axis. The known solution represents a kind of spin-on filter, where the filter head with its piping remains in place in the connected hydraulic circuit and the filter bowl as housing is unscrewed and screwed on again in conjunction with the filter element for the purpose of replacing a used filter element with a new one.

In filter devices of this type, in which, as in the case of the document referred to, element mounts are in form-fit connection with housing parts, such as connector ends of the housing and/or connector ends on the housing cover, extremely tight tolerances have to be maintained in the manufacture of filter housings and filter housing parts to ensure the axes of respective element mounts of the end caps are precisely aligned with the axes of the housing and/or cover retaining elements, such as connector ends. Manufacturing tolerances in the production of housings, in particular in the case of multi-part housing designs having several adjacent housing parts, can lead to misalignments causing distortions in the filter element, resulting in malfunctions or even damage. Filter devices having very elongated filter elements are particularly affected by this problem, because even the smallest angular errors and positional deviations entail large misalignments at the opposite retaining element.

To solve these problems, it has been proposed in WO 2020/104260 A1 for an in-tank solution of a different type, in which the filter head and a tubular filter housing remain stationary on a storage tank and a filter element is replaced by opening the filter head via its housing cover to make provision, in the area of a foot-end mount of the filter element on the filter housing, for the relevant end cap to be mounted on an element mount on the housing end, wherein a bearing providing more than one degree of freedom is used to support the filter element in an articulated manner on the element mount via this end cap. The bearing has a convexly extending bearing surface on the end cap, which is guided in a concavely extending bearing surface in the element mount, wherein the individual bearing surface is part of a shell, at least one of which has a passage for fluid. The known solution is relatively complicated and requires a large number of additional components to seal the bearing and its individual bearing surfaces in the manner of a ball joint against the tank interior to the tubular housing end.

Based on this prior art, the invention addresses the problem of further improving a filter device of the type mentioned above in such a way that misalignments and manufacturing tolerances can be compensated for, wherein at the same time a safe operating behavior is to be achieved using an efficient and cost-effective type of manufacture.

According to the invention, this problem is solved by a filter device having the features of claim 1 in its entirety and by a filter element having the features of claim 14.

In that, according to the characterizing part of patent claim 1, a compensation device is provided, which acts between the filter head and the filter element and which, as a component of the filter element, has two shell parts, one shell part of which is secured in a stationary manner in the filter element and the other shell part of which, in contrast, is designed to be movable, and in that one of the two shell parts has a passage opening for guiding a fluid flow, compensation is available for any misalignment errors, permitting an increase of the narrow tolerance limits to be complied with for production, and filter devices having long filter elements or having assembled filter housings can thus also be produced in an operationally reliable manner and at favorable production costs. Furthermore, both shell parts can be mounted in a stationary and movable manner at a central location on the filter element, which saves installation space. In particular, when the filter bowl with the filter element is screwed onto the stationary filter head, the filter device according to the invention permits the filter element to retain its installation position in the filter bowl, and any tolerance and misalignment compensation occur only at the fluid transition point between the passage opening of the compensation device and the stationary, fluid-conveying parts of the filter head.

The correspondingly designed filter element for use in a filter device of this type is when spent, in conjunction with the compensation device, replaced by a new element, such that a new compensation device is always used at the same time as the new filter element, such that any leaks that may occur in the area where the bearing surfaces contact each other in the long-term during operation are of no significance at all.

A shell in terms of the invention and as defined in engineering mechanics is a planar supporting structure that has a doubly curved surface and that, in particular, can absorb forces both perpendicularly and in its own plane. Shells make optimum use of their load-bearing capacity by distributing loads via membrane forces that are constant across the thickness of the shell, i.e., the shells have a high stiffness at a low weight.

Preferably, provision is made for one stationary shell part to be part of an end cap of the filter element and the other movable shell part to form a spherical ring, which is in contact with the stationary shell part. In this way, the shell parts are an integral part of the end cap of the filter element and are integrated in the end cap in both the axial and radial directions to save installation space. A particular advantage of this bearing design via shells using a spherical ring as the one shell part is that the passage opening in the element cap for guiding the filtrate flow is reliably sealed against the feed side of the filter device on the outside of the filter element, even for high pressures.

In a further preferred embodiment of the filter device according to the invention, provision is made for the movable shell part to have, on its end facing the filter head, an annular sealing device, which has, on its free end face facing the filter head, a sealing ring, which is pressed against the filter head in the secured state of the filter element. In this way, with increasing screw-on motion of the filter bowl on the filter head, an axial seal is achieved between the compensation device and assigned parts of the filter head, such that a secure seal is also achieved relative to the feed side of the filter device in the area of the transfer of the filtrate flow from the inside of the filter element to the filtrate outlet end of the filter head.

In a further particularly preferred embodiment of the filter device according to the invention, provision is made for a contact surface of the filter head for the sealing ring to span an obliquely extending plane. Owing to the deliberate inclination of the contact surface of the filter head, which results in an angular offset between the longitudinal axis of the passage opening in the compensation device and the corresponding longitudinal axis of parts of the filtrate outlet guide in the filter head, over-determinations are prevented, which improves the sealing effect. Furthermore, this also provides a kind of imitation protection, because conventional filter elements cannot be easily replaced in the filter device with its housing parts.

Particularly preferably provision is made with respect to the passage opening for the stationary shell part to have a concave contact surface, which, in any swivel position of the other shell part, is in contact with a convexly curved contact surface of this shell part. Furthermore, provision is preferably made for the stationary shell part to have respective stop edges for limiting a maximum possible swivel motion for this shell part at its opposite free rims, which define a hollow spherical or annular mounting space for the other swivel shell part. In this way, the movable shell part is securely supported in the stationary shell part of the filter element cap in any of its possible swivel motions, and the respective stop edges specify a maximum swivel motion for the movable shell part. The convex contact surface of the stationary shell part completely overlaps the swivel shell part in this contact area.

In a further preferred embodiment of the filter device according to the invention, provision is made for the end cap of the filter element with the two shell parts to have a sealing rim on the outer circumference for mounting a sealing ring, which projects radially in the circumferential direction beyond the outer circumference of the filter medium of the filter element. In this way, the end cap of the filter element is also sealed in the outer circumferential area by contact with both the filter bowl and the filter head.

In this case, the sealing rim of the element cap and the sealing ring preferably span a plane that is overlapped by the swivel shell part with its annular sealing device in the direction of the filter head. With increasing screw-on motion in the sense of screwing in the filter bowl with its external thread along an internally threaded section of the filter head, there is compression of the sealing ring against the sealing rim of the element cap, and compression of the axially projecting sealing rim in the form of the sealing ring against the free end face of the movable shell part, which is integrally connected to this shell part.

For a smooth flow of fluid within the filter device, provision is preferably made for the sealing rim of the end cap to be kept at a distance from the stationary shell part by means of individual bars and for individual apertures to be provided between the bars and the sealing rim. In this case, the individual spacer bars, which assume a uniform radial spacing from one another, are favorable to the flow pattern of the flow of unfiltered matter onto the outside of the filter element.

In another preferred embodiment of the filter device according to the invention, provision is made for the filter head to comprise a spring-loaded check valve, which, in its closed position, blocks the fluid path between the passage opening of the swivel shell part and a filtrate outlet opening for guiding a filtrate flow in the filter head and, releases it in its open position. This check valve has only a low opening force and only prevents fluid from unintentionally returning to the inside of the filter element from the filtrate outlet end of the filter head. Furthermore, removing or unscrewing the filter bowl from the filter head prevents any backflow of leakage flow, which could otherwise result in clean fluid unintentionally leaking during filter element replacement. In this respect, in the closed position the closing part of the check valve preferably rests against a contact ring secured in the filter head in the fluid path in a spring-loaded manner, which contact ring forms a sealing seat for this purpose.

In another preferred embodiment of the filter device according to the invention, provision is made for the filter head to comprise at least one bypass valve, which, when particle contamination clogs the filter element, opens a fluid connection from the feed side to the filtrate outlet side in the filter head via the individual flow openings in the end cap. If the filter element becomes blocked by particle contamination, the flow of unfiltered matter, which has usually already been cleaned several times, is routed directly to the filtrate outlet side of the filter head, bypassing the filter element. This ensures continued operation of components connected to the hydraulic circuit.

The filter element according to the invention, in particular provided for the filter device described above, comprises the relevant features concerning the compensation device in one of the element caps and the circumferential sealing device having a replaceable sealing ring.

The particular embodiment of a filter element to this effect is the subject of the dependent claims 15 et sqq.

Below, the filter device according to the invention and the filter element will be explained in more detail based on an exemplary embodiment according to the drawing. In the figures, in schematic representation, not to scale,

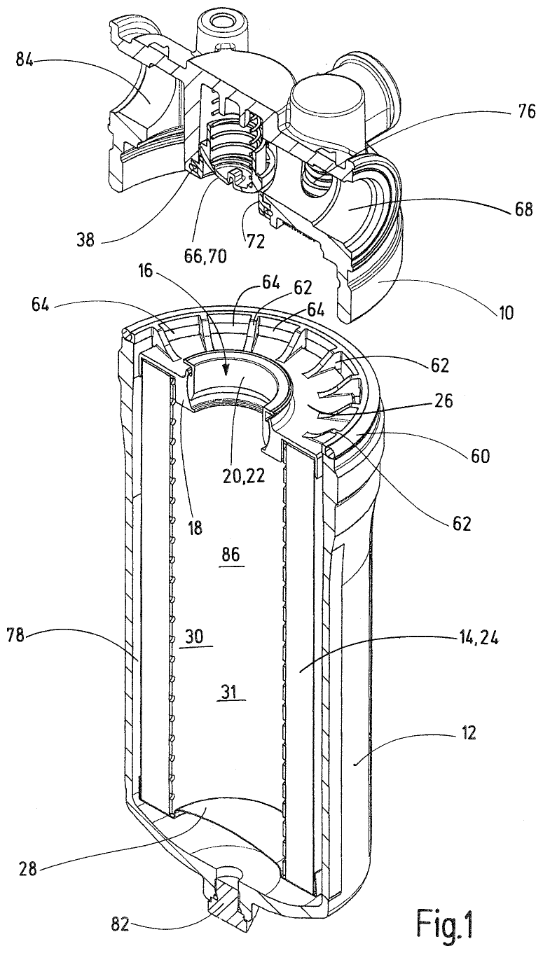

FIG. 1 shows a longitudinal section of the filter element mounted in a filter bowl and the filter head, located above as viewed in the direction of view of FIG. 1, in the manner of an exploded view;

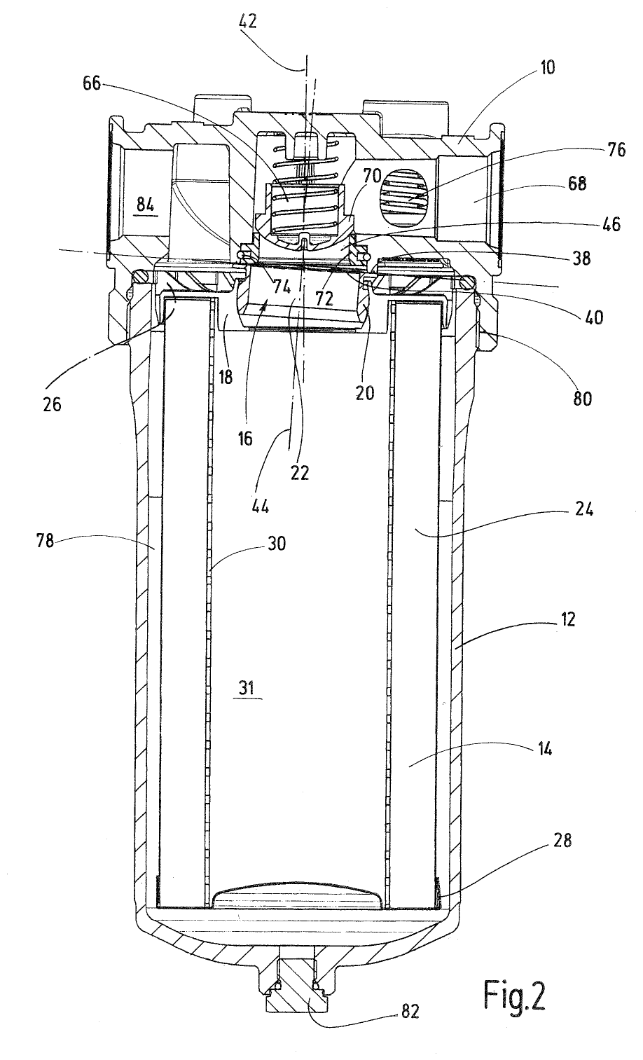

FIG. 2 shows a longitudinal section of the object of FIG. 1, in which the filter bowl with the filter element is inserted into the filter head by screwing it in; and

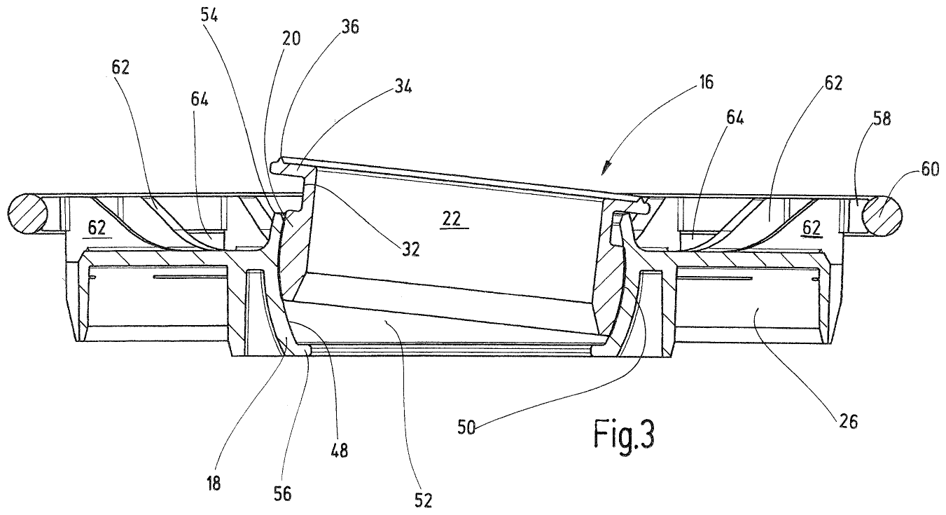

FIG. 3 shows a longitudinal sectional view of the upper element cap of the filter element shown in FIGS. 1 and 2, including compensation device and outer circumferential sealing rim geometry with O-shaped sealing ring.

The filter device shown in FIG. 1 and its individual components shown as a longitudinal section has a filter head 10 and a filter bowl 12, in which a replaceable filter element 14 is mounted. Between the filter head 10 and the filter element 14 there is a compensation device, designated as a whole by 16, as shown in more detail in FIG. 3. The compensation device 16 is part of the filter element 14 and has two shell parts 18, 20, one shell part 18 of which is secured in a stationary manner at the filter element 14 and the other shell part 20 of which, in contrast, is designed to be guided in a movable manner. Further, the inner shell part 20 has a cylindrical passage opening 22 for routing a fluid flow.

The filter element 14 comprises a filter medium or filter element material 24 extending between an upper end cap 26 and a lower end cap 28. Further, the element material 24, when viewed from the outside in the direction of flow, is supported on a cylindrical perforated support tube 30, which comprises a cylindrical interior of the filter element 14 as a chamber for filtrate matter 31. A bottom portion of the lower end cap 28 is used to close off this chamber for filtrate matter 31 at the bottom. Otherwise, the compensation device 16 and its two shell parts 18, 20 are an integral part of the upper end cap or element cap 26. In particular, the stationary shell part 18 is an integral part of the upper end cap 26, which is obtained, for example, by a plastic injection molding process. The other movable shell part 20 has the form of a spherical ring, the outer circumference of which is in contact with the inner circumference of the stationary shell part 18. A spherical ring in terms of this invention solution is the central portion of a solid sphere, which consists of a sphere having a cylindrical drilled hole, which forms the passage opening 22 in this way. It is delimited on the outside by a symmetrical spherical zone and on the inside by the lateral surface of a straight circular cylinder (Wikipedia). Insofar as the movable shell part 20 is tilted according to the fluid guide based on the illustration according to FIG. 3, the exposed cross-section of the stationary shell part 18 likewise forms a portion of the penetration opening 22.

An annular sealing device 34 is provided axially spaced apart from the shell part 20 via an annular spacer groove 32, which sealing device 34 has a sealing ring 36 on its free flat end face facing the filter head 10, which sealing ring 36 is pressed in a sealing manner against adjacent parts of the filter head 10 in the secured state as shown in FIG. 2. When viewed in cross-section, the sealing ring 36 is formed from a triangular sealing lip that is an integral part of the movable shell part 20. The outer circumference of the sealing device 34 is larger in diameter than the outer diameter of the shell part 20 at its widest, central point.

As can be seen in particular from the illustration according to FIG. 2, the assigned annular contact surface 38 of the filter head 10 for the sealing ring 36 spans an obliquely extending plane 40. In the secured state of the filter bowl 12 on the filter head 10, the compensation device 16 as shown in FIG. 3 necessarily follows this flat course of the plane 40 for a sealing process. Thus, an angular offset is created between a longitudinal axis 42 of the filter head 10 and a longitudinal axis 44 through the center of the movable shell part 20. In this respect, then, the longitudinal axis 44 is perpendicular to the imaginary plane 40. For this inclination of the plane 40, the contact surface 38 on the opposite end is used to extend the circular or cylindrical filtrate opening 46 in the filter head 10 on the right-hand side in a bar-like manner relative to the assigned contact bar, wherein the bar guide transitions smoothly from short to long bar length, but is in any case overlapped at the rim by the sealing ring 36 of the sealing device 34, which sealing ring is in contact with the contact surface 38. The mentioned angular offset between the longitudinal axes 42, 44 including the obliquely inclined plane 40 in conjunction with the assigned sealing device 36 clearly demonstrates that the compensation device 16 can easily compensate for any irregularities present in this area due to the material, including misalignments. In this case, however, the inclined arrangement for the plane 40 has been deliberately chosen in order to obtain imitation protection in the sense that conventional filter elements cannot be easily substituted as a counterfeit for the filter device according to FIGS. 1 and 2.

As further shown in FIG. 3, with respect to the central passage opening 22, the stationary shell part 18 has a concave contact surface 48, which is in contact with a convexly curved contact surface 50 of the other shell part 20 in any swivel position of this shell part 20. The curvatures of the contact surfaces 48, 50 match each other in such a way that the shell part 20 can slide smoothly in the shell part 18. As can be further seen from FIG. 3, the stationary shell part 18 has stop edges 54, 56 on its respective opposite free edges defining a hollow spherical or annular mounting space 52 for the swivel shell part 20 for limiting a maximum possible swivel motion of the movable shell part 20. When the shell part 20 is in its maximum deflected position as shown in FIG. 3, the lower edge of the sealing device 34 strikes the upper stop edge 54 and the lower stop edge 46 is drawn radially inwards towards the center of the penetration opening 22 and can thus help limit the swivel motion of the shell part 20, providing additional safeguard if for any reason the upper stop edge 54 should unintentionally give way.

The upper end cap 26 of the filter element 14 with the two shell parts 18, 20 has a sealing rim 58 on the outer circumference for mounting a sealing ring 60, for example in the form of an O-ring made of an elastomer material. As can be seen from the figures, the sealing ring 60, as viewed in the circumferential direction, projects radially beyond the outer circumference of the filter medium or filter element material 24 of the filter element 14 at every point. In particular, the sealing ring 60 is replaceably mounted in an annular groove in the sealing rim 58 and projects upwards and downwards beyond the sealing rim 58 at a slight axial projection in the unpressed condition. The sealing rim 58 of the end cap 26 extending therefrom spans an imaginary plane with the mentioned sealing ring 60, which is partially overlapped by the annular sealing device 34 of the swivel shell part 20 in the direction of the filter head 10 according to the illustration of FIG. 3, at least on the left side. In this way, two independent sealing systems 36, 60 are created, which can be adapted to any installation situation of the filter element 14, to create a reliable seal between the chambers for unfiltered matter and the chambers for filtrate matter of the filter device while compensating for tolerance errors and bearing errors and including protection against plagiarism during the operation of the filter device.

Individual bars 62 are used to space the sealing rim 58 of the end cap 26 apart from the stationary shell part 18, wherein the bars 62 extend radially outwards. The bars 62, which project beyond an outer circumferential rim of the end cap 26, widen in height and transition as an integral part of the end cap 26 along the inner circumference into the sealing rim 58, which projects beyond the projection of the bars 62 outwards beyond the outer circumference of the end cap 26. Because of the said spacing, individual apertures 64 are formed between the bars 62 and the sealing rim 58.

As can be seen in particular from FIGS. 1 and 2, the filter head 10 has a spring-loaded check valve 66, which, in its closed position shown in the figures, blocks the fluid path between the passage opening 22 of the swivel shell part 20 and a filtrate outlet opening 68 for guiding a filtrate flow in the filter head 10 and, in its open position, discharges the filtrate as a filtrate drain into piping on the filter head 10, which is not shown in greater detail. In its closed position, the dome-shaped closing part 70 of the valve 66 is supported in a spring-loaded manner on a contact ring 72 secured in the fluid path in the filter head 10, which in this respect forms a sealing seat for the check valve 66. A snap ring 74 is used to retain this contact ring 72 in the fluid recess in the filter head 10.

Furthermore, the filter head 10 has at least one bypass valve 76, which is only partially shown in FIGS. 1 and 2 and which, when the filter element 14 is clogged with particle contamination, opens a fluid connection from the feed side 78 to the filtrate outlet side or the filtrate outlet opening 68 in the filter head 10 via the individual flow openings 64 in the upper end cap 26. A screw connection 80 is used to connect the filter bowl 12 with the filter element 14 to the filter head 10 in a detachable manner, wherein as the screw-on depth increases, the sealing ring 60 of the filter element 14 is pressed against the filter head 10 forming a seal, just like the sealing ring 36 on the free end face of the swivel shell part 20.

The filter bowl 12 is designed to be closed at the bottom and has a drain plug 82 at the bottom, and in the assembled operating position of FIG. 2, unfiltered matter in the form of fluid flows, for instance
in the form of a hydraulic medium containing particulate contamination, into the chamber for unfiltered matter, which forms the feed side 78, via the inlet 84 and via the window-like apertures 64. The flow of unfiltered matter then continues to flow from the outside to the inside and then, cleaned of particle contamination by the element material 24, into the chamber for filtrate matter 31 and thus to the filtrate side 86. From there, the filtrate flow reaches the filtrate outlet side 68 in the filter head 10 via the compensation device 16 with the penetration opening 22 and after it has passed the open check valve 66. When the filter bowl 12 is removed from the stationary filter head 10 via the screw connection 80, the outer circumferential sealing ring 60 is released, the underside of which and the sealing rim 58 then rest on the free end face at the upper bowl end of the filter bowl 12. During this unscrewing process, the check valve 66 is closed and no leakage flow can unintentionally escape to the outside. Any fluid still present in the filter bowl 12 can be drained to the surroundings via the drain plug 82, into a receptacle not shown in more detail. The filter element 14 can then be removed via the top of the filter bowl 12 and, if necessary, replaced with a new element or alternatively cleaned. Afterwards, the filter bowl 12 with the new element 14 ready for operation in this way has to be screwed onto the filter head 10 again. The technical term “screwing on” is to be equated here with the actual screwing-in process of the filter bowl 12 into the filter head 10, which protrudes at the rim.

The solution according to the invention can be used to combine a filter element having an outer seal 60 with a spherically mounted inner part 20 of the element cap 26. The outer ring 58 with seal 60 clamps the element 14 between the head 10 and the cup-like housing 12. This creates a force in the axial direction along the longitudinal axis 42 pressing the spherical cap 20 onto the sealing seat; formed from components 38 of the filter head 12. This sealing seat is disposed in an inclined manner in the head 10 and the spherically mounted inner part 20 of the cap 26 can compensate for this inclined position. The axial bracing via the screw connection 80 presses the sealing edge 36 onto the sealing seat of the filter head 10 and also braces the spherical bearing with the shell parts-18, 20, in this way sealing them against each other. This is without parallel in the prior art.

1. A filter device having a filter head (10) and having a filter bowl (12) for mounting a replaceable filter element (14), characterized in that a compensation device (16) is provided, which acts between the filter head (10) and the filter element (14) and which, as a component of the filter element (14), has two shell parts (18, 20), one shell part (18) of which is secured stationarily to the filter element (14) and the other shell part (20) of which, in contrast, is designed to be movably guided, and in that one of the two shell parts (20) has a passage opening (22) for guiding a fluid flow.

2. The filter device according to claim 1, characterized in that the one stationary shell part (18) is part of an end cap (26) of the filter element (14) and that the other movable shell part (20) forms a spherical ring in contact with the stationary shell part (18).

3. The filter device according to claim 1, characterized in that the movable shell part (20) has, on its end facing the filter head (10), an annular sealing device (34), which has, on its free end face facing the filter head (10), a sealing ring (36), which is pressed against the filter head (10) in the secured state of the filter element (14).

4. The filter device according to claim 1, characterized in that a contact surface (38) of the filter head (10) for the sealing ring (36) spans an obliquely extending plane (40).

5. The filter device according to claim 1, characterized in that, with respect to the passage opening (22), the stationary shell part (18) has a concave contact surface (48), which, in any swivel position of the other shell part (20), is in contact with a convexly curved contact surface (50) of this shell part (20).

6. The filter device according to claim 1, characterized in that the stationary shell part (18) has respective stop edges (54, 56) for limiting a maximum possible swivel motion for this shell part (20) at its opposite free rims, which define a hollow spherical or annular mounting space (52) for the other swivel shell part (20).

7. The filter device according to claim 1, characterized in that the end cap (26) of the filter element (14) with the two shell parts (18, 20) has a sealing rim (58) on the outer circumference for mounting a sealing ring (60), which projects radially in the circumferential direction beyond the outer circumference of the filter medium (24) of the filter element (14).

8. The filter device according to claim 1, characterized in that the sealing rim (58) of the end cap (26) and the sealing ring (60) span a plane that is at least partially overlapped by the swivel shell part (20) with its annular sealing device (36) in the direction of the filter head (10).

9. The filter device according to claim 1, characterized in that the sealing rim (58) of the end cap (26) is kept at a distance from the stationary shell part (18) by means of individual bars (62), and in that individual apertures (64) are provided between the bars (62) and the sealing rim (58).

10. The filter device according to claim 1, characterized in that the filter head (10) comprises a spring-loaded check valve (66), which, in its closed position, blocks the fluid path between the passage opening (22) of the swivel shell part (20) and a filtrate outlet opening (68) for guiding a filtrate flow in the filter head (10) and releases it in its open position.

11. The filter device according to claim 1, characterized in that in the closed position the closing part (70) of the check valve (68) rests against a contact ring (72) secured in the filter head (10) in the fluid path a spring-loaded manner, which contact ring forms a sealing seat.

12. The filter device according to claim 1, characterized in that the filter head (10) comprises at least one bypass valve (76), which, when particulate contamination clogs the filter element (14), opens a fluid connection from the feed side (78) to the filtrate outlet side (68) in the filter head (10) via the individual apertures (64) in the end cap (26).

13. The filter device according to claim 1, characterized in that a screw connection (80) is used to connect the filter bowl (12) with the filter element (14) to the filter head (10) in a detachable manner and in that as the screw-on depth increases, the sealing ring (60) of the filter element (14) is pressed against the filter head (10) forming a seal, just like the sealing ring (36) on the free end face of the swivel shell part (20).

14. A filter element, in particular for a filter device according to claim 1, characterized in that a compensation device (16) is provided, which is a component of the filter element (14) and which has two shell parts (18, 20), one shell part (18) of which is secured in a stationary manner at the filter element (14) and the other shell part (20) of which, in contrast, is guided movably, and in that one of the two shell parts (20) has a passage opening (22) for guiding a fluid flow.

15. The filter element according to claim 14, characterized in that the one stationary shell part (18) is part of an end cap (26) of the filter element (14) and that the other movable shell part (20) forms a spherical ring in contact with the stationary shell part (18).

16. The filter element according to claim 14, characterized in that the movable shell part (20) has an annular sealing device (34), which has a sealing ring (36) projecting axially towards the surroundings on its free end face.

17. The filter element according to claim 14, characterized in that, with respect to the passage opening (22), the stationary shell part (18) has a concave contact surface (48), which, in any swivel position of the other shell part (20), is in contact with a convexly curved contact surface (50) of this shell part (20).

18. The filter element according to claim 14, characterized in that the stationary shell part (18) has respective stop edges (54, 56) for limiting a maximum possible swivel motion of this shell part (20) at its opposite free rims, which define a hollow spherical or annular mounting space (52) for the other swivel shell part (20).

19. The filter element according to claim 14, characterized in that the end cap (26) of the filter element (14) with the two shell parts (18, 20) has a sealing rim (58) on the outer circumference for mounting a sealing ring (60), which projects radially in the circumferential direction beyond the outer circumference of the filter medium (24) of the filter element (14).

20. The filter element according to claim 14, characterized in that the sealing rim (58) of the end cap (26) and the sealing ring (60) span a plane that is at least partially overlapped by the swivel shell part (20) with its annular sealing device (34) axially projecting in the direction of the surroundings, in that the sealing rim (58) of the end cap (26) is kept at a distance from the stationary shell part (18) by means of individual bars (62), and in that individual apertures (64) are provided between the bars (62) and the sealing rim (58).
